(19) United States
(12) Patent Application Publication
(10) Pub. No.: US 2011/0138867 A1
(43) Pub. Date: Jun. 16, 2011

(54) FIXED CODED LOCK

(76) Inventor: Leo Lai, Guangdong Province (CN)

(21) Appl. No.: 12/678,470

(22) PCT Filed: Dec. 1, 2008
(86) PCT No.: PCT/CN2008/073274

§ 371 Date: Mar. 16, 2010

(30) Foreign Application Priority Data
Aug. 29, 2008 (CN) 200820189355.X

(51) Int. Cl. E05B 37/20; E05B 37/00

(52) U.S. Cl. 70/320; 70/286

(57) ABSTRACT

The present invention relates to the technical field of coded locks, in particular to a fixed coded lock. The fixed coded lock comprises a casing, a latch hook return device that is used to push the front end portion of a latch hook into the casing is arranged inside the casing; the middle portion of the latch hook return device is hinged to the casing, and the latch hook return device respectively extends to form a pushing portion and a pressing portion respectively from the hinge point; the pushing portion pushes against the latch hook, and the pressing portion extends outside the casing; the front end portion of the latch hook is withdrawn into the casing through the latch hook return device which is manufactured by applying the lever principle, and the latch hook is withdrawn into the casing by pressing a key, so that unlocking becomes easier and more labor-saving for users.

### FIELD OF THE INVENTION

The present invention relates to the technical field of coded locks, in particular to a fixed coded lock. The present invention is based on the Chinese patent application No. 200820189355.X for utility model, filed on Aug. 29, 2008, and the content disclosed in the foregoing patent application is involved here for reference.

### BACKGROUND OF THE INVENTION

A fixed coded lock is usually provided with a latch catch lock position and a latch hook; for example, the Chinese patent titled as Case Coded Lock with its publication number being CN201053242 filed on Jun. 19, 2007 by the present applicant disclosed a fixed coded lock, which in the casing comprises a latch hook spring for forcing the front end portion of the latch hook to extend into the latch catch lock position, a lock core for locking the latch hook, and a turntable structure for unlocking the lock core; when the latch hook extends outwardly, the front end portion of the latch hook will close the opening of the latch catch lock position, and the lock core will lock the latch hook; when the turntable of the turntable structure is not turned to the proper unlocking position, or when there is no valid key to unlock the lock core, the latch hook can not be withdrawn, so that the latch hook and the latch catch lock position form an effective lock catch; when the turntable of the turntable structure is turned to the proper unlocking position, or the lock core is unlocked by a valid key, the latch hook will not be blocked by the lock core, so the latch hook is released, and at this time, if the push key on the casing is pushed, the push key will drive the front end portion of the latch hook to withdraw into the casing of the fixed coded lock. But, the movement of the push key is rectilinear, and the push key is pushed along the motion direction of the latch hook; the effective applied force pushing the push key and the spring force of the latch hook spring are at the same straight line, and the push force must be bigger than the spring force of the latch hook spring to be capable of withdraw the front end portion of the latch hook; however, the spring force of the latch hook spring is comparatively big, so, pushing the push key along a straight line is very arduous, and it is inconvenient for the user to unlock the lock.

### SUMMARY OF THE INVENTION

An object of the present invention is aiming at the disadvantages of the conventional art to provide a fixed coded lock, of which the front end portion of the latch hook is withdrawn into the casing through the latch hook return device which is manufactured by applying the lever principle, and the latch hook is withdrawn into the casing by pressing a key, so that unlocking becomes easier and more labor-saving for users.

To achieve the above mentioned object, the present invention provides the following technical solutions.

A fixed coded lock comprises a casing, and a latch hook; the casing is provided with a latch catch lock position, and the latch hook is located inside the casing; a latch hook spring for forcing the front end portion of the latch hook to extend into the latch catch lock position is provided inside the casing, and the front end portion of the latch hook will close the opening of the latch catch lock position as the front end portion extends into the latch catch lock position; a latch hook return device for pushing the front end portion of the latch hook into the casing is arranged inside the casing; the middle portion of the latch hook return device is hinged to the casing, and the latch hook return device respectively extends to form a pushing portion and a pressing portion respectively from the hinge point; the pushing portion pushes against the latch hook; the pressing portion extends outside the casing.

Wherein, the pressing portion extending out of the casing is a press key.

Of course, the pressing portion extending out of the casing can also be a driving lever.

Wherein, the quantity of the latch hook is two, and the two latch hooks are stacked up and down; the pushing portion of the latch hook return device pushes against the back end portions of the two latch hooks, and the front end portions of the two latch hooks are respectively inserted into the two latch catch lock positions on the casing.

Of course, the pushing portion can also push against the front end portion of the latch hook.

Or, the pushing portion pushes against the middle portion of the latch hook.

Wherein, the latch hook return device is a special-shaped part of L-shaped part or V-shaped part, of which the turning point is the hinge point.

The advantages of the present invention are that: in the present invention, a latch hook return device that is used to push the front end portion of a latch hook into the casing is arranged inside the casing; the middle portion of the latch hook return device is hinged to the casing, and the latch hook return device respectively extends to form a pushing portion and a pressing portion respectively from the hinge point; the pushing portion pushes against the latch hook, and the pressing portion extends outside the casing; the front end portion of the latch hook is withdrawn into the casing through the latch hook return device which is manufactured by applying the lever principle, and the latch hook is withdrawn into the casing by pressing a key, so that unlocking becomes easier and more labor-saving for users.

Furthermore, in the present invention, the latch hook is withdrawn into the casing through pressing the press key or pushing the driving lever, and the press key is nonperishable and convenient, so that unlocking becomes easier and more labor-saving for users.

### BRIEF DESCRIPTION OF THE DRAWINGS

FIG. 1 is a structure schematic diagram of the present invention;

FIG. 2 is a structure schematic diagram of the present invention as the back casing is hidden;

FIG. 3 is a structure schematic diagram of the present invention as the press key is pressed;

FIG. 4 is a structure schematic diagram of the present invention as the back casing is hidden and the press key is pressed.

### DESCRIPTION OF THE PREFERRED EMBODIMENT

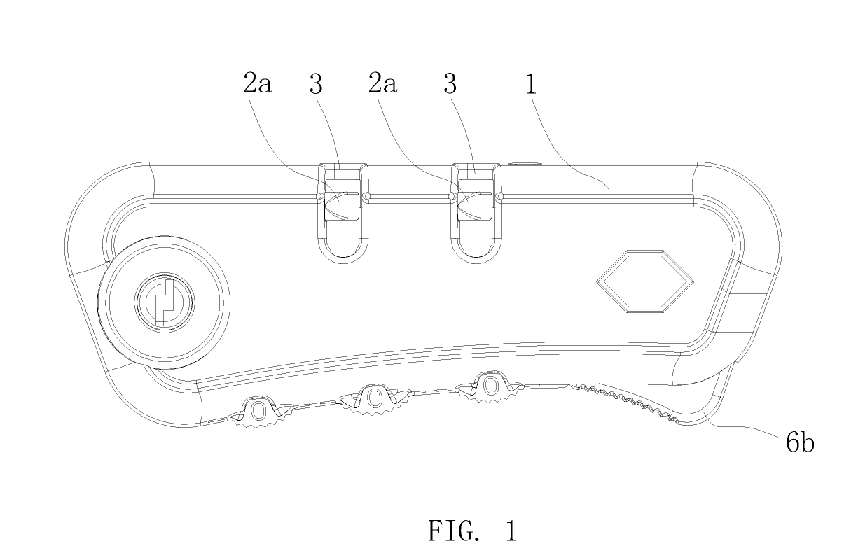

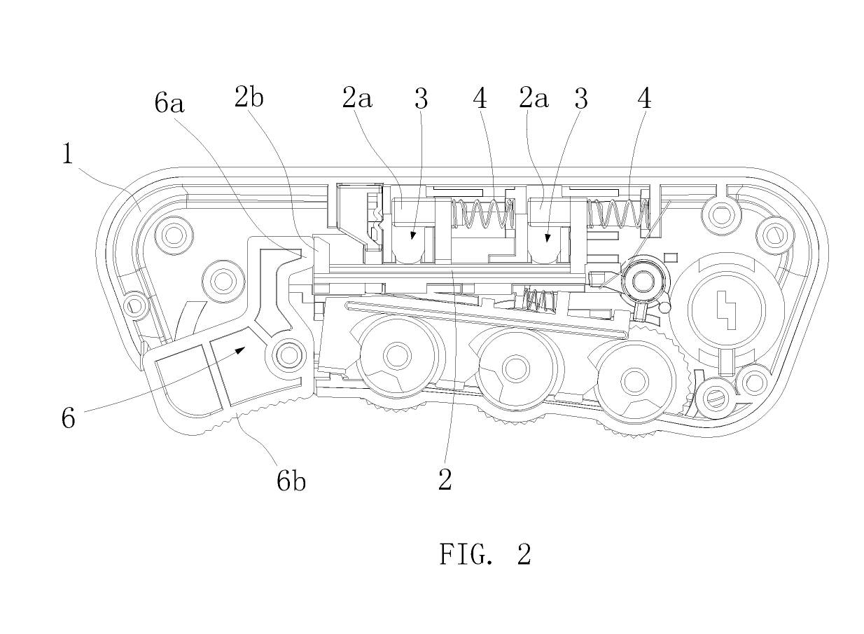

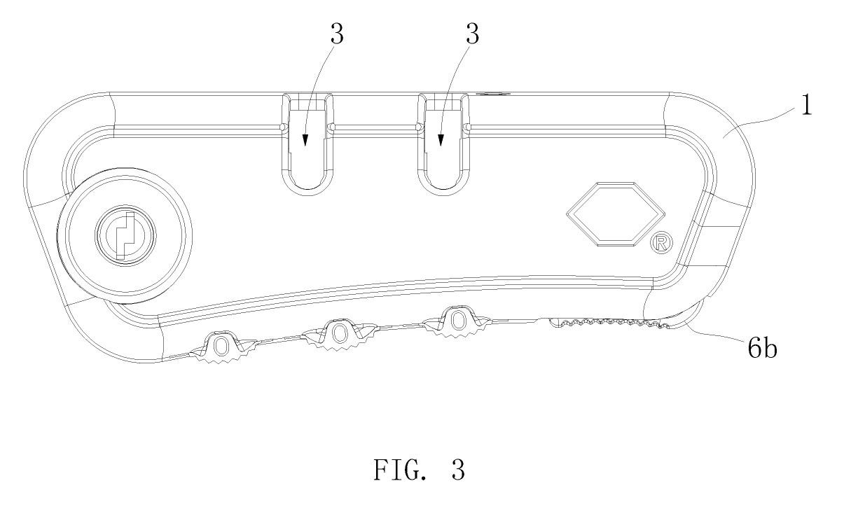

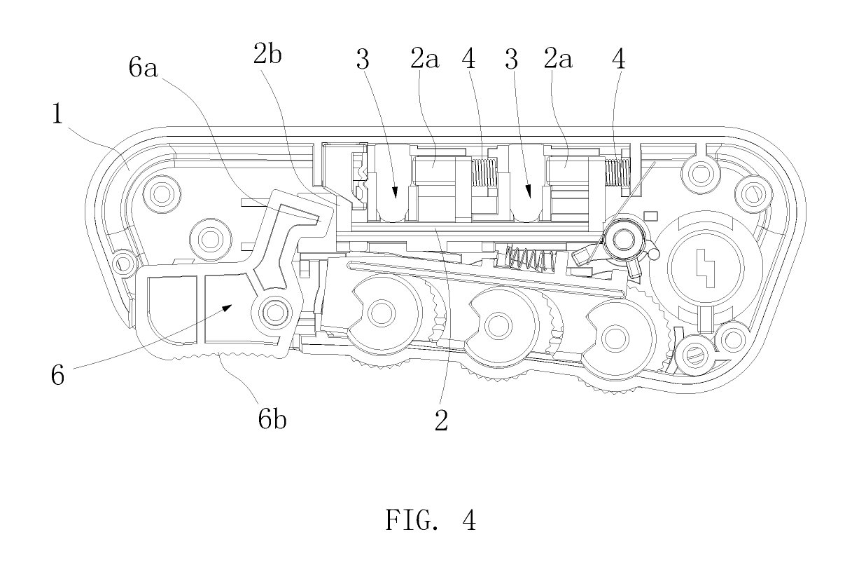

Referring to FIGS. 1-4, the fixed coded lock of the present invention comprises a casing 1, and a latch hook 2; the casing 1 is composed of a front casing and a back casing; the casing 1 is provided with a latch catch lock position 3, and the latch hook 2 is located inside the casing 1; a latch hook spring 4 for forcing the front end portion 2a of the latch hook 2 to extend into the latch catch lock position 3 is provided inside the casing 1, and the front end portion 2a of the latch hook 2 will close the opening of the latch catch lock is position 3 as the front end portion 2a extends into the latch catch lock position 3; a latch hook return device 6 for pushing the front end portion 2a of the latch hook 2 into the casing 1 is arranged inside the casing 1; the middle portion of the latch hook return device 6 is hinged to the casing 1, and the latch hook return device 6 respectively extends to form a pushing portion 6a and a pressing portion 6b respectively from the hinge point; the pushing portion 6a pushes against the latch hook 2; the pressing portion 6b extends outside the casing 1, and the pressing portion 6b extending out of the casing 1 is a press key. Of course, the pressing portion 6b extending out of the casing 1 can also be a driving lever. The pressing portion 6b extending out of the casing 1 actually is one end for the user to control; it is nonperishable and designed for being more labor-saving and convenient for the user, and all it has to do is to make the pushing portion 6a of the latch hook return device 6 to push the latch hook 2 by controlling the pressing portion 6b.

The quantity of the latch hook 2 is two, and the two latch hooks 2 are stacked up and down; the pushing portion 6a of the latch hook return device 6 pushes against the back end portions 2b of the two latch hooks 2, and the front end portions 2a of the two latch hooks 2 are respectively inserted into the two latch catch lock positions 3 on the casing 1.

Of course, the pushing portion 6a pushes against the front end portion 2a of the latch hook 2, or, the pushing portion 6a pushes against the middle portion of the latch hook 2; the only object to achieve is that when the latch hook 2 is driven to move backward, the front end portion 2a of the latch hook 2 can withdraw from the latch catch lock positions 3.

The latch hook return device 6 is a special-shaped part of L-shaped part or V-shaped part, of which the turning point is the hinge point.

Although the present invention has been described in detail with above said preferred embodiments, but it is not to limit the scope of the invention. So, all the modifications and changes according to the characteristic and spirit of the present invention, are involved in the protected scope of the invention.

### INDUSTRIAL APPLICABILITY

In the present invention, the front end portion of the latch hook is withdrawn into the casing through the latch hook return device which is manufactured by applying the lever principle, and the latch hook is withdrawn into the casing by controlling the pressing portion, so that unlocking becomes easier and more labor-saving for users; this structure can be widely used in all kinds of coded locks, and has a good market prospect.

What is claimed is:

1. A fixed coded lock comprising a casing (1), and a latch hook (2); the casing (1) being provided with a latch catch lock position (3), and the latch hook (2) being located inside the casing (1); a latch hook spring (4) for forcing the front end portion (2a) of the latch hook (2) to extend into the latch catch lock position (3) being provided inside the casing (1), and the front end portion (2a) of the latch hook (2) closing the opening of the latch catch lock position (3) as the front end portion (2a) extending into the latch catch lock position (3); characterized in that a latch hook return device (6) for pushing the front end portion (2a) of the latch hook (2) into the casing (1) is arranged inside the casing (1); the middle portion of the latch hook return device (6) is hinged to the casing (1), and the latch hook return device (6) respectively extends to form a pushing portion (6a) and a pressing portion (6b) respectively from the hinge point; the pushing portion (6a) pushes against the latch hook (2), and the pressing portion (6b) extends outside the casing (1).

2. The fixed coded lock of claim 1, wherein the pressing portion (6b) extending out of the casing (1) is a press key.

3. The fixed coded lock of claim 1, wherein the pressing portion (6b) extending out of the casing (1) is a driving lever.

4. The fixed coded lock of claim 1, wherein the quantity of the latch hook (2) is two, and the two latch hooks (2) are stacked up and down; the pushing portion (6a) of the latch hook return device (6) pushes against the back end portions (2b) of the two latch hooks (2), and the front end portions (2a) of the two latch hooks (2) are respectively inserted into the two latch catch lock positions (3) on the casing (1).

5. The fixed coded lock of claim 1, wherein the pushing portion (6a) pushes against the front end portion (2a) of the latch hook (2).

6. The fixed coded lock of claim 1, wherein the pushing portion (6a) pushes against the middle portion of the latch hook (2).

7. The fixed coded lock of claim 4, wherein in that the latch hook return device (6) is a special-shaped part of L-shaped part or V-shaped part, of which the turning point is the hinge point.
